(19) United States
(12) Patent Application Publication
(10) Pub. No.: US 2015/0041516 A1
(43) Pub. Date: Feb. 12, 2015

(54) STRUCTURE OF STAPLING DEVICE

(71) Applicant: JANN YEI INDUSTRY CO., LTD., TAICHUNG CITY (TW)

(72) Inventor: TON-YI CHEN, TAICHUNG CITY (TW)

(73) Assignee: JANN YEI INDUSTRY CO., LTD., TAICHUNG CITY (TW)

(21) Appl. No.: 14/146,729

(22) Filed: Jan. 3, 2014

(30) Foreign Application Priority Data
Aug. 6, 2013 (TW) 102128070

(51) Int. Cl. B25C 5/06

(52) U.S. Cl. CPC B25C 5/06
USPC 227/107

(57) ABSTRACT

A stapling device includes two casing members, a pad seat, and a striker plate. The casing members, which can be combined together, have front ends respectively forming front-end plates abutting each other. The two casing members are rotatably coupled to a press-down handle that is selectively pressed down. The pad seat is set at the front end of the interior of the two combined casing members. The pad seat has a front end face, which define, collectively with the inside surfaces of the front-end plates of the two casing members, a striker plate channel. The striker plate is slidably received in the striker plate channel. The striker plate is selectively pulled by the press-down handle to move upward. The two casing members clamp and retain therebetween a spring plate for providing a striking pre-loading force to the striker plate.

### (a) TECHNICAL FIELD OF THE INVENTION

The present invention relates to the technical field of metal-casing stapling devices, and more particularly to a structure of a metal-casing stapling device, which reduces the number of components, lowers down assembling cost, provide a cushioning effect, and extends the lifespan of the stapling device.

### (b) DESCRIPTION OF THE PRIOR ART

Stapling devices are generally divided into two categories, which are metal-casing stapling devices and plastic-casing stapling device. A known metal-casing stapling device comprises a casing that is composed of two side covers 51 that mates and are connectable to each other and a front lid 52. In order to form a striker plate channel 54 along which a staple striker plate 53 is slidable, the front lid 52 is additionally mounted to a front end of the combined side covers 51. Further, due to the fact that the metal side covers 51 cannot be directly formed with a spring retention slot, a compressible powerful spring 55 is additionally arranged above the staple striker plate 53 to provide the staple striker plate 53 with a downward-directing pre-loading force for staple striking and consequently, a staple striker seat 56 must be additionally arranged. This increases the components and the overall size and also raises the cost.

In other words, the design of the conventional metal-casing stapling device must take the formation of the striker plate channel and the staple-striking pre-loading into consideration and thus, the number of components is increased and the structure is complicated. This in turn makes the assembling difficult and raises the manufacturing cost. Further, the conventional device has a poor effect of absorbing striking force during the staple striking operations so that, being acted upon by long term successive striking, the components may get easily loosened due to vibrations. This affects the performance of staple striking and also leads to damage and shortening of lifespan. Since the conventional metal-casing stapling device is not perfect, further improvements are desired.

### SUMMARY OF THE INVENTION

Thus, the primary object of the present invention is to provide a simplified structure of a stapling device, in order to reduce the number of components and the overall size, alleviate the difficult of manufacturing and assembling, and also lower down the manufacturing cost.

The present invention adopts the following technical solution to achieve the above object and desired performance, which comprises:

two casing members, which are combinable to each other, the two casing members having front ends respectively forming front-end plates that abut each other, the two casing members comprising a press-down handle rotatably coupled thereto to be selectively pressed down with a front end of the press-down handle simultaneously movable upwards;

a pad seat, which is set in a front end of an interior of the two combined casing members, the pad seat having a front face, which define, collectively with inside surfaces of the front-end plates of the two casing members, a striker plate channel; and

a striker plate, which is slidably received in the striker plate channel defined between the front-end plates of the two casing members and the pad seat, the striker plate being selectively driven by the press-down handle to move upward, the two casing members comprising a spring plate that has a front end coupled to the striker plate retained therebetween to provide a downward-directing striking pre-loading force when the striker plate is moved upward.

As such, with the above-described technical solution so provided, the design of forming front-end tabs on two casing members of the stapling device according to the present invention to define, collectively with a pad seat, a striker plate channel for slidably receiving therein a staple striker plate and clamping and retaining a spring plate between two casing members to provide the staple striker plate with a striking pre-loading force with the spring plate enables the present invention to form an external device casing by simply combining the two casing members without inclusion of a staple striker seat that is conventionally used to generate a striking pre-loading force for a staple striker plate, whereby the present invention can greatly simplifies the structure, making it easy for manufacturing and assembling and effectively lowering down the cost.

Another object of the present invention is to provide a structure of a stapling device of high safety, which can effectively absorbs the impact force induced by striking of staples in order to alleviate loosening caused by vibration and effectively extend the lifespan.

The present invention adopts the following technical solution to achieve the above object and desired performance, wherein the pad seat has a top to which a flexible pad is mounted to be depressed by the spring plate and the flexible pad is made of a rubber material to provide a cushioning effect.

As such, when the spring plate is moved downward for position returning, the underside of the front end thereof hits the flexible pad mounted to the top of the pad seat and a cushioning effect is induced to alleviate vibration caused by staple striking so as to prevent components from getting loosened and damaged due to vibration.

In summary, the present invention provides significant improvements in various aspects regarding simplification of structure, reduction of cost, and extension of lifespan.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is a schematic view illustrating inside details of the present invention.

FIG. 3A is a cross-sectional view of a portion of the present invention, viewed from the top side.

FIG. 4 is a cross-sectional view of a portion of the present invention, viewed from the front side.

FIG. 5 is a cross-sectional view of the present invention, viewed from a lateral side.

FIG. 6 is a schematic view illustrating an operation of the present invention viewed from a lateral side.

FIG. 7 is a schematic view illustrating another operation of the present invention viewed from a lateral side.

FIG. 8 is an exploded view showing another embodiment of the present invention.

FIG. 9 is a schematic view showing inside details of said another embodiment of the present invention.

FIG. 10 is an exploded view of a portion of a conventional metal-casing stapling device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

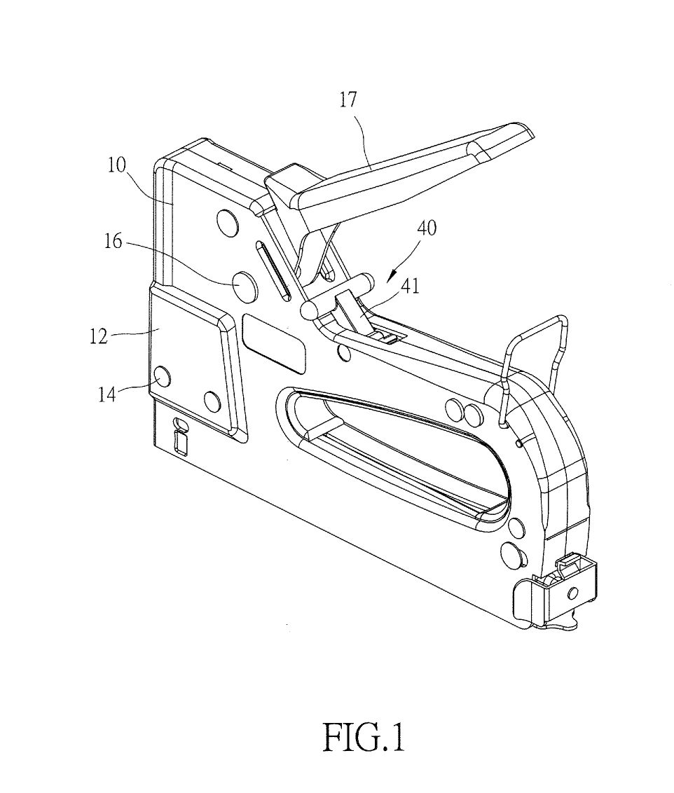

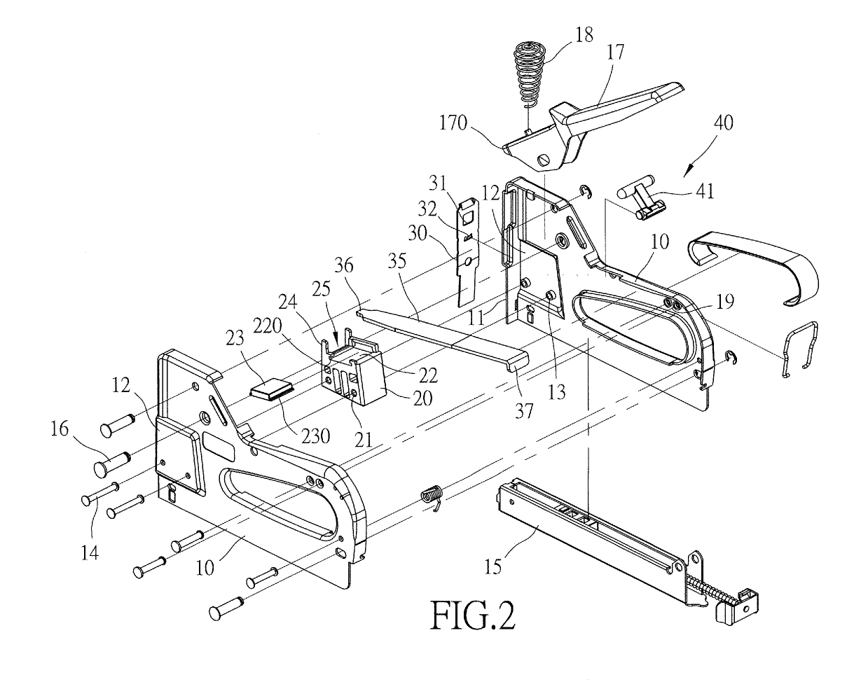

The present invention provides a structure of a stapling device, which, as shown in FIGS. 1 and 2, comprises two casing members 10 that are mateable and combinable with each other. The two casing members 10 are rotatably coupled, by means of a pivot pin 16, to a press-down handle 17 that is selectively depressible downward. The two casing members 10 comprises therein a striker plate channel 25 that is formed in a pad seat 20 arranged at the bottom of the front end thereof. The striker plate channel 25 slidably receives therein the striker plate 30 that is selectively pulled by the press-down handle 17. The striker plate 30 receives a pre-loading force from a spring plate 35 arranged between the two casing members 10 for generating a powerful downward-directing impact force.

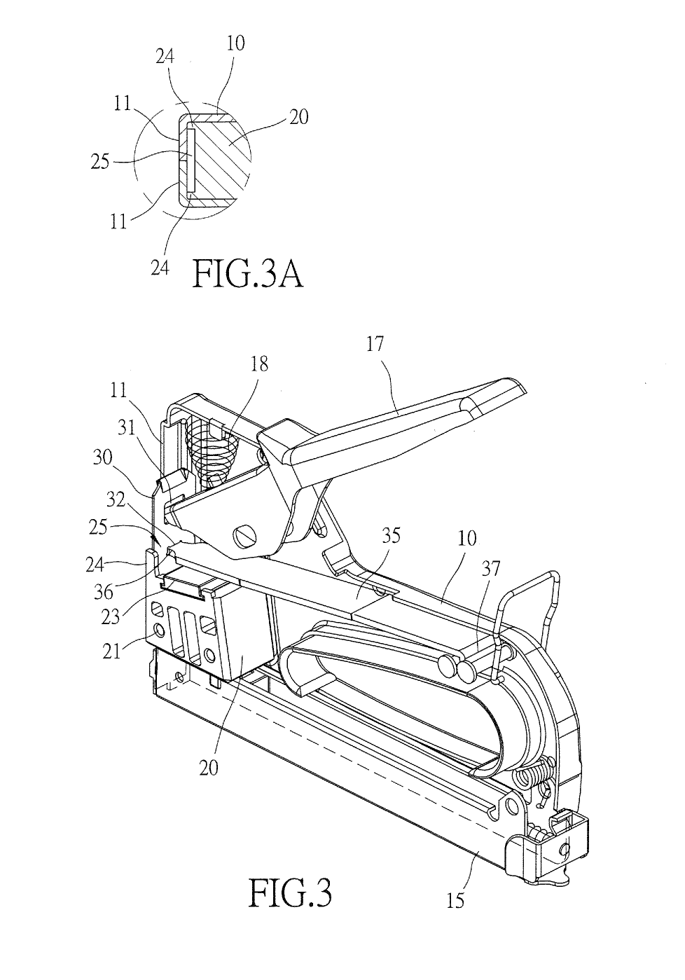

Details of the structure of the stapling device will be described with reference to FIGS. 2 and 3. The two casing members 10 have lying U-shapes that oppose each other. The two casing members 10 have front ends from which front-end plates 11 extend to abut each other. Further, the two casing members 10 each is bulged out at a lower portion thereof adjacent to the front-end plate 11 through stamping to form a positioning recess section 12 for accommodating the pad seat 20. Further, the casing members 10 each comprise at least one holed positioning post 13 that is formed in the positioning recess section 12 and extends inwardly for receiving a corresponding fixing rivet 14 to extend therethrough and penetrate through the pad seat 20. Further, the two casing members 10 have bottoms where a staple magazine assembly 15 in which staples are loaded in an automatically feeding manner is arranged to allow the striker plate 30 to strike the staples out of the staple magazine assembly 15 one by one. The press-down handle 17 that is rotatably coupled by the pivot pin 16 is arranged above the pad seat 20 and the press-down handle 17 has a front end that forms hook 170 that is selectively set in hooking engagement with the striker plate 30. Further, the press-down handle 17 has an end projecting out of top walls of the two casing members 10. Further, the two casing members 10 supports a compression spring 18 between inside surfaces of the top walls thereof and a front end of the press-down handle 17 to provide a pre-loading force for downward returning to the press-down handle 17. Further, the two casing members 10 comprise opposite clamping sections 19 formed on inside surfaces thereof at a rear end thereof for clamping and retaining a rear end of the spring plate 35 of the striker plate 30.

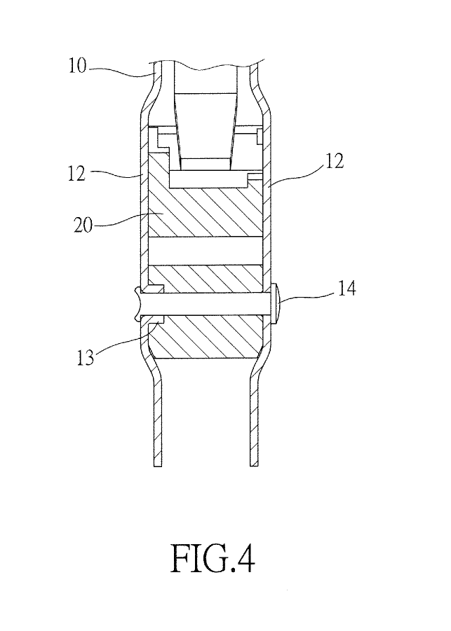

Further, the pad seat 20 is accommodated in the positioning recess sections 12 when the two casing members 10 are combined with each other. The pad seat 20 is made of plastics and the pad seat 20 is formed with a positioning hole 21 corresponding to the holed positioning posts 13 of the casing members 10, whereby the pad seat 20 is secured in position between the two casing members 10 by the holed positioning posts 13 and the fixing rivet 14 (as shown in FIG. 4). Further, the pad seat 20 has a top in which a slot 22 is formed to receive and hold therein a flexible pad 23 that allows the spring plate 35 to contact therewith in a downward movement. The flexible pad 23 is made of a rubber material or the likes to provide a cushioning effect. Further, the slot 22 and the flexible pad 23 are respectively provided, at two opposite sides thereof, with sideway grooves 220 and sideway wings 230 that are engageable with and mutually fit to each other to securely fix the flexible pad 23 to the top of the pad seat 20. Further, the pad seat 20 has a front face having two opposite sides each forming a front lateral tab 24 for abutting engagement with an inside surface of the front-end plate 11 of the corresponding one of the two casing members 10 so that the front face of the pad seat 20 and the inside surfaces of the front-end plates 11 of the casing members 10 collectively define the striker plate channel 25 in which the striker plate 30 is slidably received.

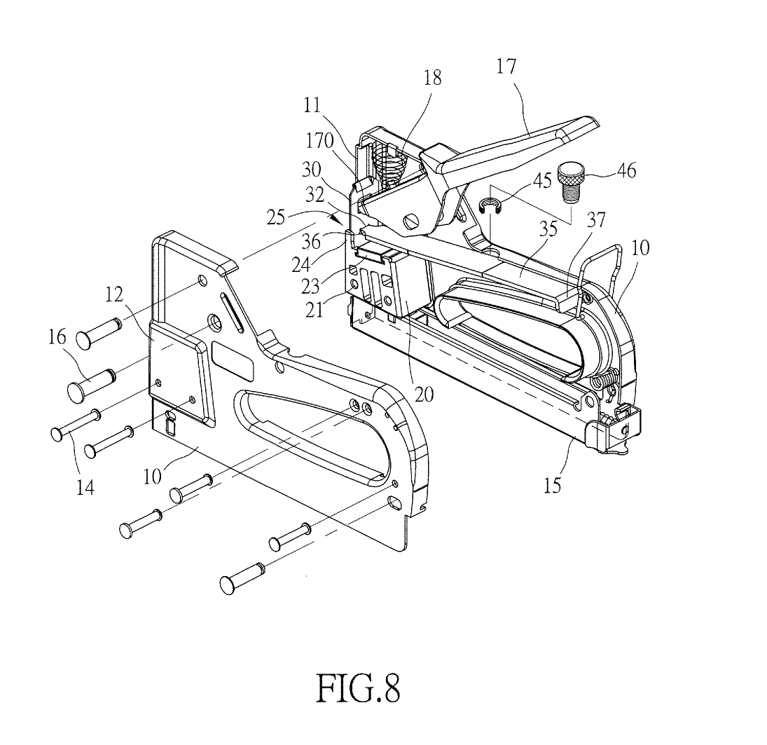

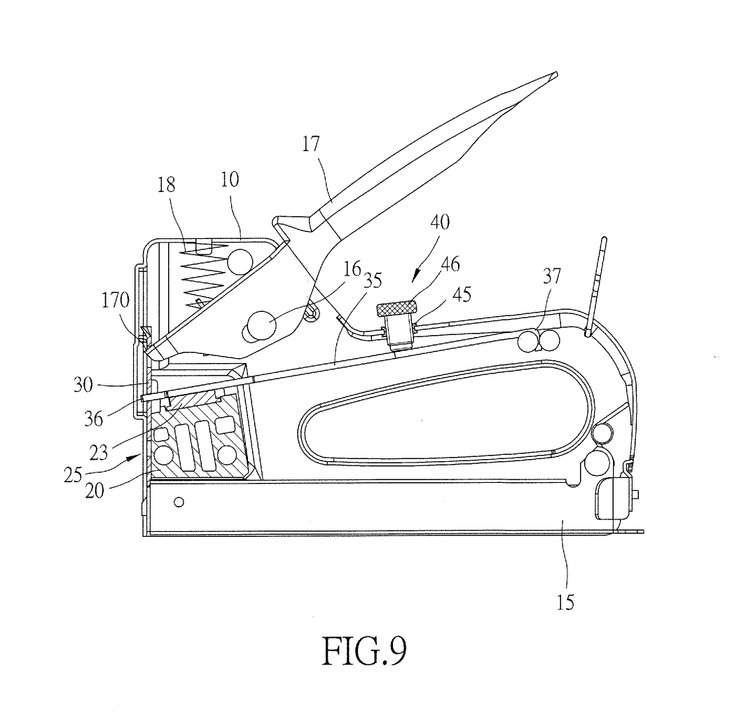

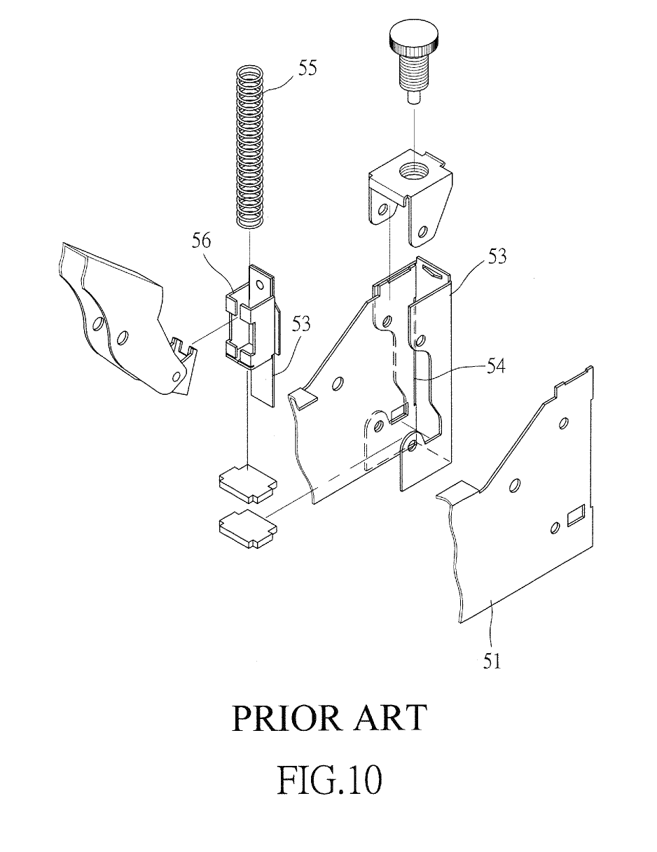

Further, the striker plate 30 is slidably received in the striker plate channel 25 of the pad seat 20 and the striker plate 30 comprises a hook hole 31 formed in an upper section thereof to receive the hook 170 of the press-down handle 17 to selectively engage therewith or disengage therefrom. Further, the striker plate 30 comprises an insertion hole 32 formed in an intermediate section thereof and the spring plate 35 comprises a corresponding inserting section 36, whereby the front end of the spring plate 35 can be fixed to the striker plate 30. Further, an opposite end of the spring plate 35 forms a bent section 37 to allow the rear end of the spring plate 35 to be clamped and retained between the clamping sections 19 of the two casing members 10. The two casing members 10 comprise a pressure adjustment member 40 arranged on the top walls thereof to serve as a fulcrum of the spring plate 35 and functioning for adjusting the pre-loading force for staple striking, whereby when the striker plate 30 is driven by the press-down handle 17 to move upward, the spring plate 35 is caused to generate, with respect to the pressure adjustment member 40, a staple-striking pre-loading force that induces a powerful downward-directing strike. The pressure adjustment member 40 comprises an I-shaped pressing bar 41 that is set in supporting engagement with the spring plate 35. Further, the pressure adjustment member 40 may have alternative forms of embodiments. As shown in FIGS. 8 and 9, the pressure adjustment member 40 is constructed to comprise a threaded collar 45 secured between the two casing members 10 and an adjustment bolt 46 that is threadingly received in the threaded collar 45 and has a bottom end abutting an intermediate section of the spring plate 35 to serve as a fulcrum for the spring plate 35 and functioning to adjust the staple-striking pre-loading force of the spring plate 35.

As such, a structure of a stapling device that has a simple structure and an extended lifespan is provided.

With the above-described structural arrangement, the stapling device of the present invention has a structure, which as a whole, is illustrated in FIGS. 2 and 3. Since the two casing members 10 comprise the front-end plates 11 that close the front end side thereof, since the front-end plates 11 of the two casing members 10 and the pad seat 20 collectively define therebetween the striker plate channel 25 in which the striker plate 30 is slidable, and since the two casing members 10 comprise the clamping sections 19 for clamping and retaining the spring plate 35 to have the intermediate section of the spring plate 35 supported by the pressure adjustment member 40 and to have the spring plate 35 caused to generate a striking pre-loading force at the same when the striker plate 30 is driven by the press-down handle 17 to move upward, compared to the conventional metal-casing stapling device, the present invention provides a device casing that can be simply formed by mating two casing members 10 without inclusion of a staple striker seat that is employed in the conventional device for handling the impact force generated by a striker plate so that the structure is greatly simplified, making it easy to manufacture and assemble and costs of parts and manufacturing lowered down.

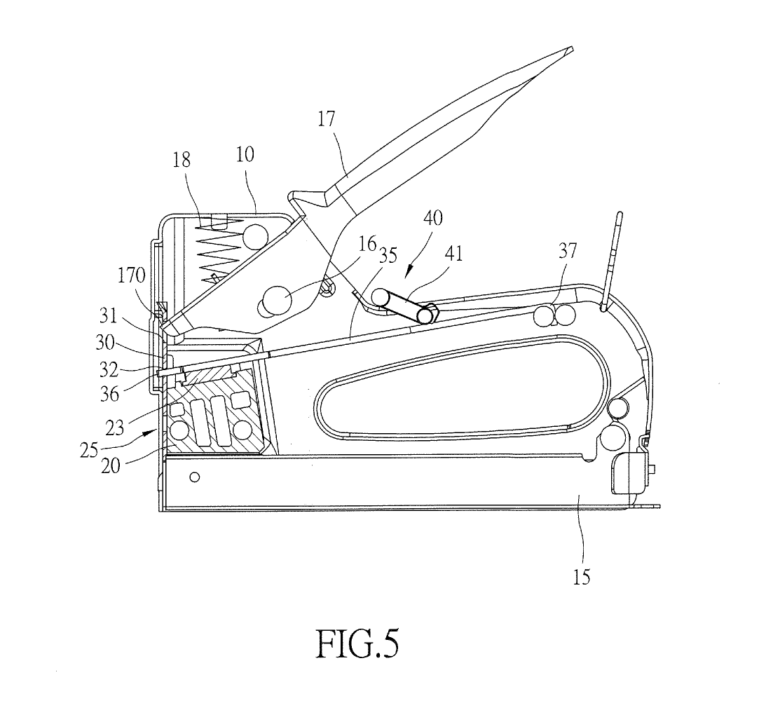

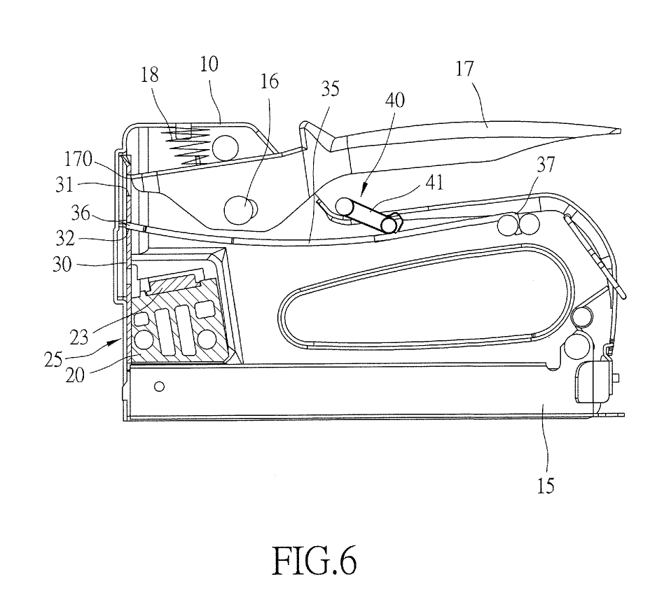

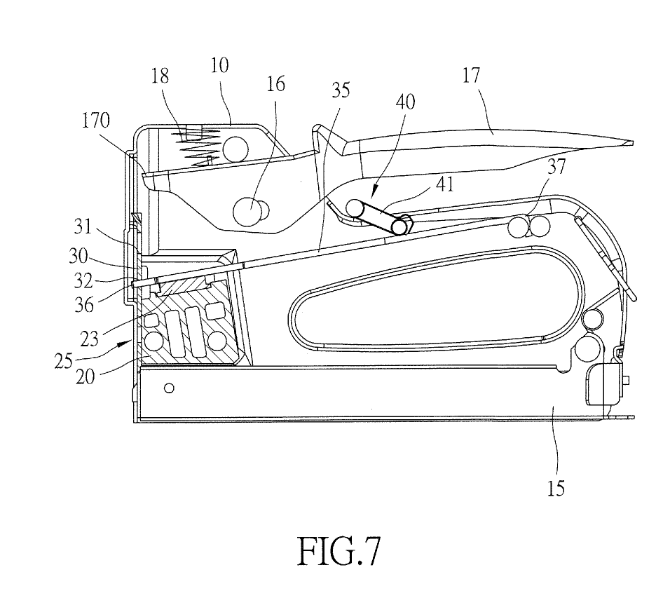

In a practical operation, as shown in FIGS. 5, 6, and 7, when a user presses down the press-down handle 17, since the hook 170 of the press-down handle 17 is in engagement with the hook hole 31 of the striker plate 30, the downward depression of the press-down handle 17 simultaneously drives the striker plate 30 to move upward. Since the front end of the spring plate 35 is inserted, with the inserting section 36, into the insertion hole 32 of the striker plate 30, with the pressure adjustment member 40 as a fulcrum, the spring plate 35 is caused to generate a force resulting from elastic deformation thereby providing a striking pre-loading force that drives the striker plate 30 downward to strike a staple out (as shown in FIG. 6). When the front end of the press-down handle 17 is raised to a predetermined location, the hook 170 is allowed to disengage from the hook hole 31 of the striker plate 30 so that the striker plate 30 is acted upon by the downward-directing striking pre-loading force of the spring plate 35 to move downward within the striker plate channel 25 of the pad seat 20 and powerfully strike the staples contained in the staple magazine assembly 15 located in the underside thereby achieving the purpose of stapling an object with the stapling device.

Further, when the spring plate 35 moves back in a downward direction for position returning, the undersurface of the front end thereof is arranged to hit the flexible pad 23 mounted to the top of the pad seat 20, by which a cushioning effect is induced to alleviate the vibration caused by staple striking, whereby loosening and damage of parts resulting from the vibration can be prevented and the lifespan can thus be extended.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A stapling device, comprising:
two casing members, which are combinable to each other, the two casing members having front ends respectively forming front-end plates that abut each other, the two casing members comprising a press-down handle rotatably coupled thereto to be selectively pressed down with a front end of the press-down handle simultaneously movable upwards;
a pad seat, which is set in a front end of an interior of the two combined casing members, the pad seat having a front face, which define, collectively with inside surfaces of the front-end plates of the two casing members, a striker plate channel; and
a striker plate, which is slidably received in the striker plate channel defined between the front-end plates of the two casing members and the pad seat, the striker plate being selectively driven by the press-down handle to move upward, the two casing members comprising a spring plate that has a front end coupled to the striker plate retained therebetween to provide a downward-directing striking pre-loading force when the striker plate is moved upward.

2. The stapling device according to claim 1, wherein the two casing members each comprise a positioning recess section that is formed by bulging outward a lower portion of a front end thereof corresponding to the pad seat through stamping for accommodating the pad seat.

3. The stapling device according to claim 2, wherein the casing members each comprise at least one inwardly-projecting holed positioning post formed in the positioning recess section thereof and the pad seat comprises a corresponding positioning hole to receive a corresponding fixing rivet to extend therethrough for fixing the pad seat.

4. The stapling device according to claim 1, wherein the two casing members support, between inside surfaces of top walls thereof and a front end of the press-down handle, a compression spring for providing a position-returning pre-loading force to the press-down handle.

5. The stapling device according to claim 1, wherein the two casing members comprise opposite clamping sections formed on inside surfaces of rear ends thereof and the spring plate has an end forming a bent section so that the two casing members clamp and secure the spring plate in position.

6. The stapling device according to claim 1, wherein the pad seat has a top to which a flexible pad is mounted to be depressed by the spring plate, the flexible pad being made of a rubber material to provide a cushioning effect.

7. The stapling device according to claim 6, wherein the top of the pad seat forms a slot for receiving the flexible pad therein, the slot and the flexible pad being respectively provided, at opposite sides thereof, with sideway grooves and sideway wings that are engageable with each other to securely fix the flexible pad to the top of the pad seat.

8. The stapling device according to claim 1, wherein the pad seat has a front end face having two opposite sides forming front lateral tabs respectively abutting inside surfaces of the front-end plates of the two casing members to define the striker plate channel in which the striker plate is slidably received.

9. The stapling device according to claim 1, wherein the two casing members comprise a pressure adjustment member arranged on the top walls thereof to provide a fulcrum to the spring plate and for adjustment of the striking pre-loading force, the pressure adjustment member comprising an I-shaped pressing bar supporting an intermediate section of the spring plate.

10. The stapling device according to claim 1, wherein the two casing members comprise a pressure adjustment member arranged on the top walls thereof to provide a fulcrum to the spring plate and for adjustment of the striking pre-loading force, the pressure adjustment member comprising a threaded collar fixed between the two casing members and an adjustment bolt threadingly engageable with the threaded collar and having an end abutting an intermediate section of the spring plate.
